(19) United States
(12) Patent Application Publication
(10) Pub. No.: US 2025/0139940 A1
(43) Pub. Date: May 1, 2025

(54) PREGENERATION OF TELEOPERATOR VIEW

(71) Applicant: Zoox, Inc., Foster City, CA (US)

(72) Inventor: Brendan Zachary Zilong Johnston, Burlingame, CA (US)

(21) Appl. No.: 18/385,713

(22) Filed: Oct. 31, 2023

(51) Int. Cl. G06V 10/74; B60W 60/00; G06T 5/00; G06T 15/20; G06V 20/58; H04N 7/18

(52) U.S. Cl. CPC G06V 10/761; B60W 60/005; G06T 5/70; G06T 15/205; G06V 20/58; H04N 7/183; G06T 2207/20081; G06T 2207/20084; G06T 2207/30241; G06T 2207/30252; G06T 2210/12

(57) ABSTRACT

A remote operation system may provide, to remote operators of autonomous vehicles that have requested assistance traversing an environment, predicted views of the environment to account for latency in networking and/or computing that may cause an original view to be stale by the time it's presented at a remote operator's device. The remote operation system may initialize a connection to an autonomous vehicle for remote operator assistance, the request including sensor data associated with the autonomous vehicle, the sensor data including an image. The remote operation system may then generate a predicted image based on the received image of the sensor data of the vehicle and display the predicted view to a remote operator.

### BACKGROUND

Semi- and fully-autonomous vehicles introduce a new set of technical challenges relative to driver-operated vehicles. For example, an autonomous vehicle may encounter a scenario that has not previously been encountered or that is complex enough that the autonomous vehicle cannot determine with a sufficient level of certainty how to traverse the scenario. In such situations, inputs from remote operators may assist the autonomous vehicle to traverse the scenario. However, latency and/or delays in presentation of information to remote operators may negatively impact the ability of the remote operators to provide such assistance.

### BRIEF DESCRIPTION OF THE DRAWINGS

The detailed description is described with reference to the accompanying figures. In the figures, the left-most digit(s) of a reference number identify the figure in which the reference number first appears. The same reference numbers in different figures indicate similar or identical items.

FIG. 1 illustrates a pictorial flow diagram of an example process for providing a remote operator with a predicted view while to assisting a vehicle.

FIG. 2 illustrates a block diagram of an example computer architecture for implementing techniques to generate example predicted view data for presentation to a remote operator, as described herein.

FIG. 3 illustrates a block diagram of an example variable autoencoder implemented by a computing device to generate example output data, as described herein.

FIG. 4 illustrates a block diagram of an example diffusion architecture to generate example output data, as described herein.

FIG. 5 illustrates a flow diagram of an example process for providing a remote operator with a predicted view while to assisting a vehicle, according to at least some examples.

FIG. 6 illustrates a block diagram including an example vehicle system architecture and remote operation system, according to at least some examples.

### DETAILED DESCRIPTION

The techniques (e.g., hardware, software, machines, and/or processes) discussed herein may include providing predicted views of an environment to remote operators of an autonomous vehicle that has requested assistance in traversing the environment. In some examples, the autonomous vehicle may periodically transmit information associated with a status of the autonomous vehicle, such as a camera view, a current mission of the vehicle, a location of the vehicle, pose of the vehicle, speed, directionality, and so forth to a remote operation system. Such information is useful to remote operator(s) in determining an action to assist the vehicle, for example, if the autonomous vehicle requests assistance to traverse the environment. Due to processing time, transmission latency or the like, the presentation of the information to the remote operator(s) may be delayed. In some examples, the remote operation system may determine predicted views of the environment to present to the remote operator in place of a view generated based on status information received from the autonomous vehicle until such information is received from the vehicle or in situations where such information is delayed by network unavailability, latency, or errors (e.g., packet loss, jitter). This predicted view may decrease the amount of time it takes to bring a teleoperator up to speed on a scenario faced by an autonomous vehicle and/or may preserve awareness of the scenario when a network connection is unstable. Additionally or alternatively, the information received from the vehicle may be stale by the time it reaches a teleoperations device. For example, if there is a network delay of two seconds, the most current sensor data may already be two or more seconds old by the time it's displayed on a teleoperations device. In some examples, using the generated display may also create a more fluid viewing environment for a teleoperator in examples when some packet data may be lost or compromised, for example. Accordingly, the techniques described herein for determining a predicted view may be used in the place of the data received from the autonomous vehicle.

More particularly, the autonomous vehicle may be in communication with a remote operation system that receives the information associated with the status of the autonomous vehicle. In some examples, the autonomous vehicle may be configured to automatically transmit the information according to predetermined schedules (e.g., every second, every minute, etc.) and/or upon the occurrence of certain events (e.g., upon request of a fleet monitoring service, upon the vehicle traveling a threshold distance, upon detection of an object, upon an inability to traverse a region, a level of uncertainty falling to or below a threshold level, passenger issues, etc.). The information may inform the remote operation system of the state of the autonomous vehicle, may indicate any number of indicators including, but not limited to, whether the autonomous vehicle is in need of assistance, a type of assistance sought, provides information regarding the vehicle's surroundings, and so forth. As noted above, such information sent by the autonomous vehicle may include sensor data (e.g., a camera view, a voxelized representation of the environment generated from lidar and/or radar data), a view generated based on sensor data, and/or a current state of vehicle, such as speed, orientation (or heading), location, etc.; whether a remote operator is communicating with and/or controlling the autonomous vehicle; a health status of components of the autonomous vehicle (e.g., brakes, microcontrollers, HVAC controllers, etc.); mission type (e.g., recharging, training, hauling passengers, picking up passengers, etc.); and so forth. The remote operation system may communicate with and monitor the status of any number of autonomous vehicles within a fleet.

The remote operation system may be associated with one or more remote operators that respond to or otherwise provide assistance to the autonomous vehicles. In some examples, from time to time, the autonomous vehicle may encounter an event that it is unable to confidently traverse, such as an event that is unpredictable in nature, poses safety concerns, is of a type that has not previously been encountered, or requires responses to spontaneous visual cues or direction from, for example, police officers or construction workers. Of course, such examples are provided for illustrative purposes only and are not meant to be so limiting. In some examples, the autonomous vehicle may be unable to plan a path to navigate around an obstacle and/or may determine that a confidence level associated with one or more maneuvers (e.g., a planned trajectory or path of the autonomous vehicle) and/or events (e.g., detection or classification of a particular object, prediction of a behavior of an object, etc.) may be insufficient (e.g., is below a threshold confidence level) to proceed autonomously. In such cases, the autonomous vehicle may send a request to the remote operation system to obtain guidance. In some examples, a passenger may initiate such a request such as, for example, by hitting a button, speaking a phrase, or by being recognized by vehicle systems as requiring assistance (e.g., responsive to user input at a user device, using internal cameras and/or microphones).

The remote operator may provide assistance to the autonomous vehicle and/or passengers within the autonomous vehicle, in any suitable manner. In some examples, the assistance may include transmitting processor-executable instructions via a network interface from the device of the remote operator to the autonomous vehicle. These instructions may cause the autonomous vehicle to perform an operation, to collaborate with the autonomous vehicle to determine an operation to perform, and/or to confirm a potential operation that the autonomous vehicle has determined. In various examples, such instructions may also comprise audiovisual messages to display to the one or more passengers. For example, the instructions may comprise an indication of a waypoint for the vehicle to reach, an affirmation of a path, a direct command, a re-shaping or labeling of an object detection, an indication of a path to follow, a re-shaping of a corridor in which the vehicle can generate a path to control the vehicle, and/or the like.

The remote operation system may receive multiple requests for assistance from a plurality of autonomous vehicles. As the requests are received, the requests may be ordered within a queue and conveyed to remote computing device(s) and their respective remote operator(s) (e.g., human operator(s) or machine-learned model(s)) for processing. In some examples, the requests may be ordered within the queue based on a time at which the request was received. Additionally, or alternatively, the requests may be prioritized based on certain safety considerations, such as a vehicle operating speed (e.g., highway operation versus city street operation), occupancy status of the vehicle (occupied or vacant, number of occupants, etc.), length of ride, traffic volume, or other factors. Regardless, upon receipt of the requests, the remote operation system may select remote operators for responding to the requests.

Upon determining a remote operator for a particular request, the remote operation system may assign the request to a remote device associated with the remote operator. In response to the request being assigned to a remote operator, the device of the remote operator may display information associated with the autonomous vehicle. Such information may include, for example, sensor data generated by the autonomous vehicle (e.g., image data, lidar data, etc.) and/or a graphical representation of the sensor data (e.g., a synthetic, computer generated scene based on the sensor data). This display may allow the remote operator to be aware of a situation of the autonomous vehicle so that the remote operator may provide guidance to the autonomous vehicle with minimum delay. Of course, any other data sent from the vehicle is contemplated to be shown or otherwise relayed to the remote operator including, for example, internal camera data, microphone data, vehicle state, etc.

As mentioned above, in some examples, the remote operation system may determine predicted view(s) of the environment to present to the remote operator in place of the received view(s). In some examples, the remote operation system may generate the predicted view of based on sensor data of the vehicle, occupancy data, prediction data, and so on.

For example, the remote operation system can generate the predicted view in an image space. In some examples, a diffusion model can exchange data with a machine learned model (e.g., a decoder, a generative model (e.g., stable diffusion), a generator of a Generative Adversarial Network (GAN), a Graph Neural Network (GNN), a Recurrent Neural Network (RNN), a transformer model, etc.) to predict future views or sensor data of the vehicle in the environment. In some examples, the predicted views output by the diffusion model and decoder may be considered by the remote operator in determining operations associated with the autonomous vehicle to improve vehicle safety by controlling the vehicle based on information that is closer to the real-time state of the vehicle.

In some examples, a decoder of a variable autoencoder can receive latent variable data from the diffusion model usable by the decoder to generate the predicted views. For example, the diffusion model can generate, based at least in part on current sensor data, bounding box data, occupancy data and/or other perception or prediction data associated with a first time, latent variable data representing discrete features of object(s) associated with a second time subsequent to the first time. Occupancy data and/or bounding box data can include, for example, orientation data indicating an orientation for each of the one or more bounding boxes. Further, the occupancy data and/or bounding box data may include identifiers or identifiable characteristics for each of the one or more bounding boxes (e.g., a color or an identifier for individual objects). In some examples, occupancy data and/or bounding box data may include a top-down view of an environment. The top-down view can represent one or more of: an attribute (e.g., position, class, velocity, acceleration, yaw, turn signal status, etc.) of an object, history of the object (e.g., location history, velocity history, etc.), an attribute of the vehicle (e.g., velocity, position, etc.), crosswalk permission, traffic light permission, and the like. The data can be represented in a top-down view of the environment to capture context of the autonomous vehicle (e.g., identify actions of other vehicles and pedestrians relative to the vehicle). In some examples, occupancy data and/or bounding box data can be represented by a graph, a vector representation, or other representation other than the top-down view of the environment. Examples are not limited to including bounding box representations. For example, some examples may include contour representations, radial encoded representations, or other representations.

The techniques can include providing an indication to a teleoperator when a generated data diverges from newly received sensor data. As disclosed herein, the generated data can be indicative of prediction of what an environmental scene is suspected of being to account for communication channel delays and the like. In some instances, the predicated environmental data may diverge from what occurs in the real life. Aspects of this disclosure deal with reducing the possibility of such divergencies. In practice, divergence may still occur in certain situations. If sufficient divergence is determined or divergence for determined for critical agents (e.g., agents that effect autonomous operations of the vehicle, cross a predicted path for the vehicle to traverse, are within a threshold distance to the vehicle, etc.), then an indication can be presented to the teleoperator. For example, a symbol, message, color, sound, or other indication can enable the teleoperator to be notified of such a divergence and react accordingly. In some examples, the divergence can further be evaluated to determine if it is likely to effect safe autonomous driving operations using various techniques. For example, a risk score may be assigned to certain agents depending on agent speed, distance, position, proximity to autonomous vehicle pathing, etc. If a divergence occurs for a vehicle with a sufficiently high-risk score, then an indication may be provided to a teleoperator. By providing such indications, the teleoperator may more efficiently and safely provide remote guidance to a vehicle by reducing distractions until the teleoperator's attention is needed with regard to generating environmental data.

The diffusion model may then send the latent variable data to the decoder. The decoder can be configured to receive the latent variable data as an input and output predicted view image data for a camera or other sensor associated with the current sensor data associated with the second time.

In some examples, the diffusion model and/or the decoder may also receive map data representing an environment as an additional input.

In various examples, the decoder can determine the object representations to represent potential actions the objects may take in the environment at a future time based on the latent variable data and/or the map data, potentially without requiring other data associated with the objects. In other words, the diffusion model can generate latent variable data associated with different objects such that, when processed by the decoder, the objects may be added into or otherwise included in the predicted view of the environment. Typically, configuring a variable autoencoder includes training a decoder to output data similar to an input of the encoder. Using the diffusion model to condition a decoder as described herein enables the decoder to output data different from the input to the encoder (e.g., object representations associated with a second time subsequent to a first time associated with the data input to the diffusion model).

In some examples, the predicted view data associated with the second time output by the decoder can be utilized as, or to generate, another input to the diffusion model. The diffusion model can generate, based at least in part on predicted view data associated with the second time, additional latent variable data representing discrete features of the object(s) associated with a third time subsequent to the second time. The diffusion model may then send the additional latent variable data to the decoder. The decoder can be configured to receive the map data and the additional latent variable data and output additional representations (e.g., view data or bounding box data) for the one or more objects associated with the third time. This process may continue by using the output of the decoder as, or to generate, further input to the diffusion model for one or more additional times or timesteps.

As described herein, models may be representative of machine learned models, statistical models, or a combination thereof. That is, a model may refer to a machine learning model that learns from a training data set to improve accuracy of an output (e.g., a prediction). Additionally or alternatively, a model may refer to a statistical model that is representative of logic and/or mathematical functions that generate approximations which are usable to make predictions.

Additionally or alternatively, the remote operation system may render the predicted view based on occupancy data, map data, perception data, and/or predication data. For example, rather than or in addition to generating a predicted view directly, the diffusion model and variable autoencoder may output predicted state data of the environment. Then, using various rendering techniques, a simulated or predicted view may be rendered for the predicted state data for presentation to the remote operator (e.g., by rendering a view using 3D models of the objects in the environment).

In some examples, the remote operation system may operate to compare received view data (e.g. sensor data) from the vehicle to previously predicted views (e.g., a predicted view previously presented to the remote operator which was generated for a time that was closest to the current received view data). For example, the remote operation system may receive data from the vehicle that was captured and/or generated by the vehicle at a time, t, but that time/may now be n seconds into the past, due to network and/or computing latency, for example. Accordingly, the techniques discussed herein may generate a predicted view for time t+n to display at the remote device. Additionally or alternatively, the techniques may comprise determining a difference between the predicted view for time++n to data captured and/or generated by the vehicle at time t+n. In some examples, the remote operation system may determine a difference or similarity between data received at a current time and a previously predicted data associated with the current time. In some examples, if the difference meets or exceeds a difference threshold or a similarity score is below a similarity score threshold, the remote operation system may take various actions such as discontinuing the presentation of predicted view data, resetting the generation of predicted view data, adapting the current state of generating predicted view data based on the differences of the current received view and the previously predicted view, or so on. Otherwise, the predicted view may be presented to the remote operator for use in controlling the autonomous vehicle. Additionally or alternatively, the difference may be used as a loss for training the machine-learned models discussed herein, such as by using gradient descent to adjust component(s) of a machine-learned model to reduce the loss. Moreover, the difference may be displayed as or may be used as a basis for a confidence score or confidence indication that is displayed to a remote operator (e.g., if the difference is rising, the remote operator may choose to manually change to the time-delayed view data or otherwise trigger operations to improve the accuracy of predicted views).

The techniques discussed herein may improve functioning of a remote operation system controlling an autonomous vehicle in a number of ways. The remote operation system may present, to the remote operator, the predicted view for the vehicle which may more accurately represent the current state of the vehicle (e.g., reducing the time delay of the presented view and/or reducing the impact of stale data on determinations by the remote operator). In some examples, using the techniques described herein, a predicted view component of the remote operation system may output predicted view(s) that accurately reflect the motion of objects in the sensor data that has taken place during the transmission of the current sensor data with greater detail thereby improving safety of the vehicle. Moreover, the techniques discussed herein may be used to maintain a view of a scenario at a vehicle, even when network instability and/or packet loss occurs. For example, the predicted view may be determined and displayed at the remote device based at least in part on determining that a network ping exceeds a threshold ping, packet loss exceeds a packet loss threshold, signal-to-noise ratio is below a signal-to-noise ratio, and/or the like.

The methods, apparatuses, and systems described herein can be implemented in a number of ways. Example implementations are provided below with reference to the following figures. The implementations, examples, and illustrations described herein may be combined. Although discussed in the context of an autonomous vehicle in some examples below, the methods, apparatuses, and systems described herein can be applied to a variety of systems. In one example, machine learned models may be utilized in driver-controlled vehicles in which such a system may provide an indication of whether it is safe to perform various maneuvers. In another example, the methods, apparatuses, and systems can be utilized in an aviation or nautical context. Additionally, or alternatively, the techniques described herein can be used with real data (e.g., captured using sensor(s)), simulated data (e.g., generated by a simulator), or any combination thereof. Furthermore, examples herein are not limited to using diffusion models and may include conditional variational autoencoders (CVAEs), generative adversarial networks (GANs), vector quantized autoencoders (VQAEs), and/or other generative models.

In some examples, the disclosed techniques can be used to reduce latency associated with a teleoperators view. For example, sensor data may be dynamically compressed to improve latency. A latency that a teleoperator views information from sensors on an autonomous vehicle can include an amount of time to traverse a communications network and an amount of time needed to process encoded sensor data. If the communication network, for example, is compromised, then less bandwidth may be able to be fed through the network without compromising latency associated with a view seen by a teleoperator. Additionally, decompressing the data or predicting images from the data may also take resources of a teleoperator station or time (e.g., more decompression, further prediction, or prediction based on more data) may take longer to accomplish given a processing constraint. The disclosed techniques may be able to adjust these factors (in addition to other factors dealing with certainty in the prediction, for example) to optimize safe and timely viewing by a teleoperator by adjusting compression, decompression, and/or predicted sensor data.

In some examples, an indication regarding uncertainty in a predicted image can be given to a teleoperator when generating images. For example, an amount of entropy or randomness in a video scene may make it less likely that a predicted view is accurate especially as the prediction extends into time. As some non-limiting examples, a confidence or certainty score may be generated based on heuristic information derived from map data or historic maneuver data, an amount of entropy or randomness in the sensor data or agent paths, and/or a length of time that the predicted data has extended beyond a real sensor data capture. The indication of the uncertainty can be determined via an icon, a color representation, or the liked and may be on a scene or object-based basis (e.g., individual objects may be colored or otherwise marked to indicate certainty around the predicted sensor data corresponding to the object). This information may be used by a teleoperator to enhance safety by understanding how reliable the data being presented may be for the teleoperator to rely upon when determining to direct a vehicle.

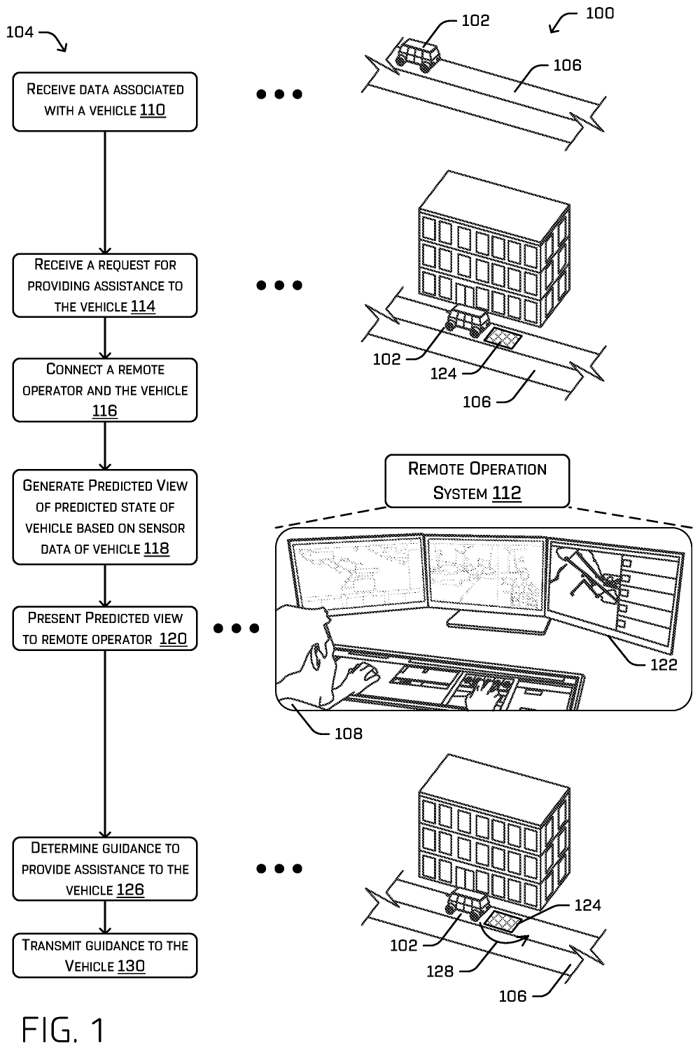

FIG. 1 is a pictorial flow diagram of an example process for providing a remote operator with a predicted view while to assisting a vehicle. FIG. 1 includes an environment 100 through which a vehicle 102 travels. The vehicle 102 may be an autonomous vehicle, such as an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle 102 at any time. In some examples, since the vehicle 102 may be configured to control all functions from start to route completion, including all parking functions, the vehicle 102 may not include a driver and/or implements for controlling the vehicle 102 such as a steering wheel, etc. In some examples, the techniques described herein may be incorporated into any ground-borne, airborne, or waterborne vehicle (or autonomous vehicle), including those ranging from vehicles that need to be manually controlled by a driver at all times, to those that are partially or fully autonomously controlled. In some examples, the vehicle 102 may represent an autonomous vehicle that is part of a fleet of autonomous vehicles.

In FIG. 1, an example process 104 is illustrated in which the vehicle 102 may operate autonomously until the vehicle 102 encounters an event (e.g., a set of conditions internal or external to the vehicle 102 including environment and operating conditions of the vehicle 102) along a road 106 for which the vehicle 102 may request assistance from, for example, a remote operator 108 located remotely from the vehicle 102. As part of this, at operation 110, the vehicle 102 may continuously or periodically transmit operational state data associated with the vehicle 102, though such transmissions need not be continuous and may be sent upon the occurrence of an event or at some interval. The operational state data may include, without limitation, current sensor data, a current state of the vehicle 102 such as speed, heading, location, whether a remote operator is connected to/controlling the vehicle 102, mission-type (e.g., carrying passengers, picking up passengers, recharging batteries of the vehicle, test-mode), and so forth.

At operation 114, the vehicle 102 may detect an event based at least in part on sensor data, such as encountering a construction zone 124 associated with a portion of the road 106, and traffic in the vicinity of the construction zone 124 may be under the direction of a construction worker who provides instructions for traffic to maneuver around the construction zone 124. Due in part to the unpredictable nature of this type of event, the vehicle 102 may transmit a request for remote assistance to a remote operation system 112. The remote operation system 112 therefore receives, at 114, a request for remote assistance to guide the vehicle 102.

At operation 116, the remote operation system 112 may assign a remote operator to respond to the request and a remote operator 108 may be connected to the vehicle 102. For example, connecting a remote computing device to the vehicle 102 may comprise establishing a network connection between the remote computing device and the vehicle 102 so that sensor data, perception data, planning data, and/or the like may be transmitted (e.g., via streaming or periodic transmissions) from the vehicle 102 to the remote computing device and/or so that guidance data may be provided from the remote computing device to the vehicle 102.

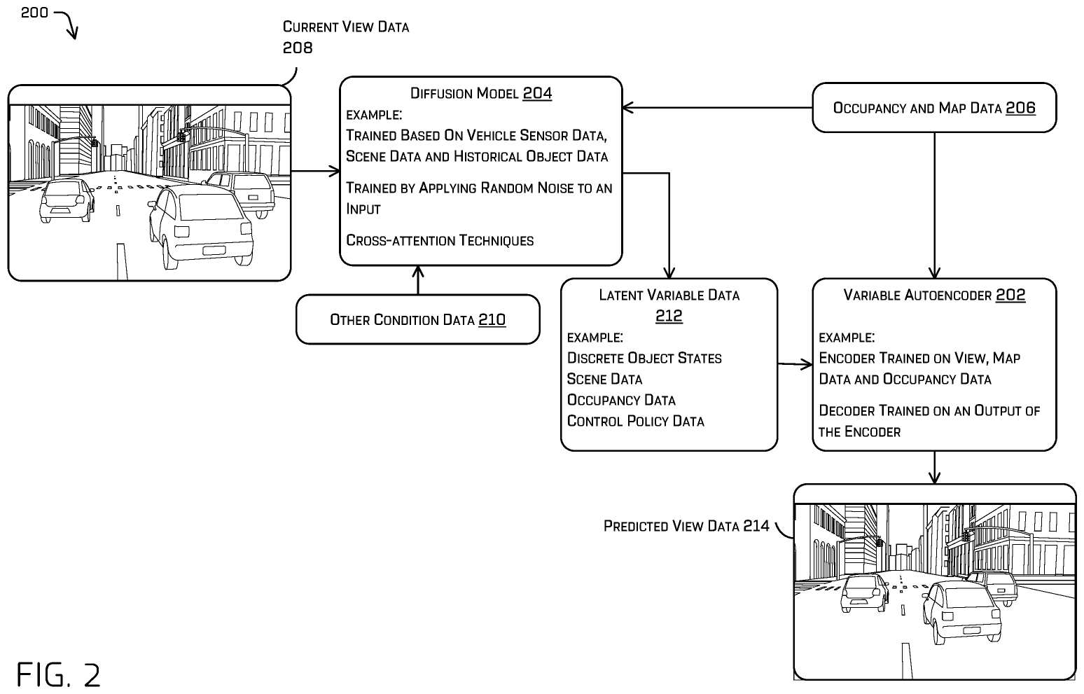

At operation 118, the remote operation system may generate a predicted view of an environment state, which may comprise a state of the vehicle, object(s) in the environment, and/or of the environment itself. For example, the remote operation system may determine predicted views of the environment to present to the remote operator in place of the received view and/or state of the autonomous vehicle. In some examples, the remote operation system 112 may generate the predicted view based on sensor data received from the vehicle, occupancy data, perception data, prediction data, planning data, etc. As discussed above, the predicted view may comprise a predicted image, a three-dimensional representation, and/or the like based on a predicted state of the environment. Further, the predicted view may be generated for a fixed time offset subsequent to the current sensor data, a variable time offset subsequent to the current sensor data (e.g., based on a latency of the current sensor data, latency of the remote computing system, latency of the network, a geolocation of the vehicle and known network statistics for that geolocation), and/or another offset (e.g. a number of internal states, processor cycles, or so on). Additional details regarding the generating predicted view(s) is provided below with respect to FIGS. 2-6.

At operation 120, the remote operation system 112 may display the predicted view via a user interface of a remote computing device to the remote operator 108. The remote operator 108 may interact with the vehicle 102 via a user interface that can include a remote operator interface. The remote operator interface may be shown on one or more displays 122 of a remote computing device and configured to provide the remote operator 108 with data related to an operation of the vehicle 102. For example, the remote operator interface may be configured to show the current view data, the predicted view data, other data related to sensor signals received from the vehicle 102, data related to the road 106, and/or additional data or information to facilitate providing assistance to the vehicle 102. Additional examples of connecting a remote operator or remotely controlling a vehicle are described in, for example, U.S. Pat. No. 11,209,822, entitled “Techniques for Contacting a Teleoperator,” the entirety of which is herein incorporated by reference for all purposes.

The remote operator 108 may utilize one or more remote computing devices associated with the displays 122, for example, that allow the remote operator 108 to provide information to the vehicle 102. Such information may be in the form of remote operation signals providing guidance to the vehicle 102. The remote operator device may include one or more of a touch-sensitive screen, a stylus, a mouse, a dial, a keypad, a microphone, a touchscreen, and/or a gesture-input system. In some examples, the remote operators 108, which may be human remote operators, may be located at a remote operations center. However, in some examples, one or more of the remote operators 108 may not be human, such as, for example, they may be computer systems leveraging artificial intelligence, machine learning, and/or other decision-making strategies and, in at least some examples, having different or more powerful computational resources or algorithms than available on the vehicle.

The remote operator 108 may provide assistance to the vehicle 102. For example, at operation 126, the remote operator 108 may determine guidance 128 that provides assistance to the vehicle 102, such as maneuvering around the construction zone 124. In some examples, the remote operator 108 may provide the vehicle 102 with guidance (e.g., direct instruction, collaboration, and/or confirmation) comprising instructions sufficient for the vehicle to determine how to avoid, maneuver around, or pass through events. Direct instruction may comprise instructions sufficient to cause the vehicle to perform a specific operation; collaboration may comprise instructions sufficient for the vehicle to determine an operation based on the instructions; and confirmation may comprise affirming or denying the accuracy of an output of the vehicle. For example, direct instruction may comprise selecting a trajectory for the vehicle to take, instructing the vehicle to open a door/aperture, or the like; collaboration instructions may comprise identifying a region in which the vehicle can operate, identifying a waypoint for the vehicle to reach, indicating when the vehicle may be released from a stopped state, or the like; and confirmation instructions may comprise affirming that an object detection or object classification is a true positive, indicating an object detection as a false positive, indicating a false negative object detection that the vehicle missed, confirming a trajectory or operation the vehicle plans to execute, or the like. Additionally, or alternatively, the remote operator 108 may communicate with passengers of the vehicle 102, for example, using a microphone, a speaker, and/or a haptic feedback device.

At operation 130, the remote operation system 112 may transmit the guidance to the vehicle (e.g. such that the vehicle may use the guidance to determine an operation of the vehicle).

Although FIG. 1 depicts a single instance of providing assistance to the vehicle 102, or providing assistance to a single vehicle, the remote operation system 112 may receive any number of requests from vehicles. For example, the vehicle 102 may be part of a fleet of vehicles in communication with the remote operation system 112.

FIG. 2 illustrates an example block diagram 200 of an example computer architecture for implementing techniques to generate example predicted view data for presentation to a remote operator as described herein. The example block diagram 200 includes a computing device (e.g., the remote operation system 112) that implements latent diffusion process using a variable autoencoder 202 and a diffusion model 204. In some examples, the techniques described in relation to FIG. 2 can be performed as the vehicle 102 navigates in the environment 100 (e.g., a real-world environment or a simulated environment).

The variable autoencoder 202 may include an encoder and a decoder to provide a variety of functionality including generating view data (e.g., the predicted view data 214). For example, a decoder of the variable autoencoder 202 may output predicted view data 214 including a predicted view based on occupancy and/or map data 206 and latent variable data 212 from the diffusion model 204 (e.g. where the latent variable data 212 is based on current view data 208). In examples, additional data may be used by a diffusion model or other techniques to generate a view for a teleoperator. For example, a trajectory of the autonomous vehicle may be used to determine how the view may change over time. Additional information regarding the autonomous vehicle may include a change to a suspension system (which may effect a height a view), road information (such as uneven surfaces that the vehicle may encounter), or changes in acceleration of speed of the vehicle.

The encoder and/or the decoder can represent a machine learned model such as a CNN, a GNN, a GAN, an RNN, a transformer model, or the like. As discussed elsewhere herein, the encoder can be trained based at least in part on the latent variable data, map data, and/or occupancy data. The occupancy data can indicate an area of the environment in which objects are likely to be located, as may be determined based at least in part on sensor data. The decoder can be trained based at least in part on a loss between the output of the decoder and an input to the encoder. In some examples, the decoder can be trained to improve a loss that takes into consideration the latent variable data 212 from the diffusion model 204. For example, parameter(s) of the encoder and/or decoder may be adjusted to reduce the loss using gradient descent.

In various examples, the decoder of the variable autoencoder 202 can receive the latent variable data 212 and the occupancy and/or map data 206. The diffusion model 204 can represent a machine learned model that implements a diffusion process trained to add noise to the input data or denoise noisy input into an image or top-down representation of the environment. For instance, the diffusion model 204 may perform a denoising algorithm based on conditional input that may incrementally denoise random image data or input data that has had random noise added thereto to generate an output. In some examples, the denoising by the diffusion model may be conditioned on a top-down representation of the environment or an image such that the space that the diffusion process samples from is conditioned based on the top-down representation, an image (e.g. the current view image) and/or other condition data. The top-down representation may comprise a data structure, such as a multi-channel image, where different channels of the image identify the existence, absence, or quality of a characteristic of the environment, as determined by the perception component based at least in part on sensor data received by the vehicle. For example, a portion of the top-down representation, such as a pixel, may indicate, depending on the channel of the image, the presence of an object at a location in the environment associated with that portion, an object classification of the object (e.g., one channel may indicate that presence or absence of a cyclist or a portion of a cyclist at a particular location in the environment), object heading, object velocity, map data (e.g., existence of a sidewalk, existence of and/or direction of travel associated with a roadway, signage location(s) and/or states, static object locations and/or classifications), and/or the like. Determining a top-down representation is discussed in more detail in U.S. Pat. No. 10,649,459, issued May 12, 2020, which is incorporated in its entirety herein for all purposes, and/or a top-down prediction associated with the environment, as described in more detail in U.S. patent application Ser. No. 16/779,576, filed Jan. 31, 2020, which is incorporated in its entirety herein for all purposes.

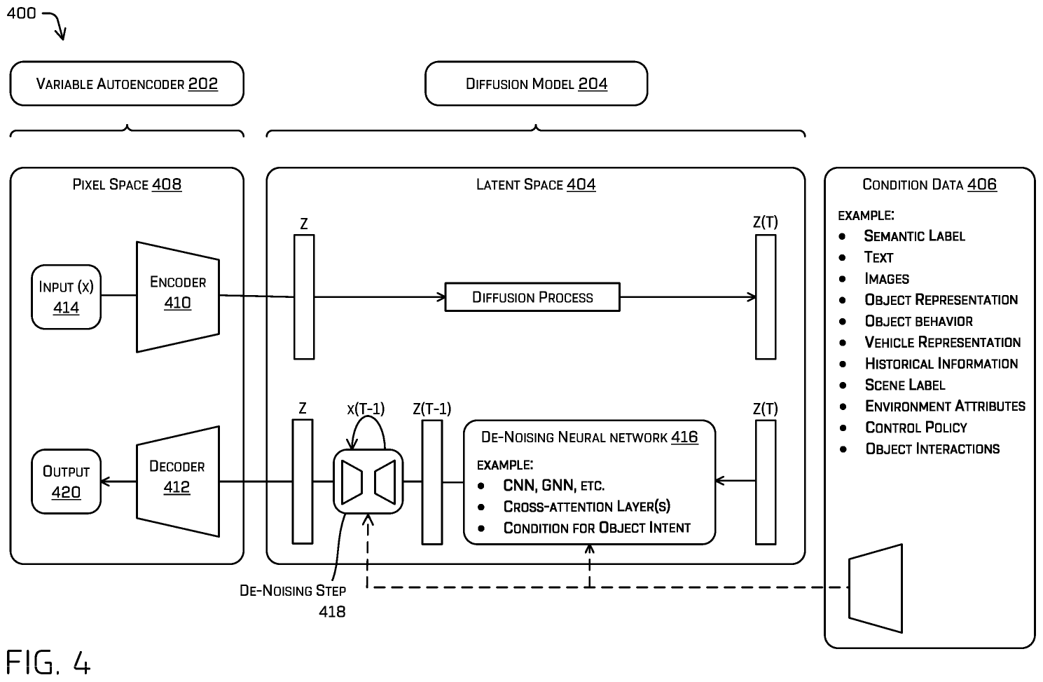

In some examples, the diffusion model 204 can perform denoising (e.g., on a random starting image or an image received from the vehicle plus some noise) based on conditional input which may include current view data 208 (e.g., associated with a first time prior to a second time associated with the predicted view data 214), the occupancy and/or map data 206, and/or other condition data 210 to output latent variables (e.g., the latent variable data 212) associated with the predicted view. In some examples, the current view data 208 may be an image from a sensor of the vehicle (e.g., associated with a first time prior to a second time associated with the predicted view data 214). The occupancy and map data 206 may include current and/or predicted occupancy data for one or more objects in the environment. For example, the occupancy data may include identifiers or identifiable characteristics for the occupancies associated with each object included in the occupancy data. For example, the current occupancy data may be an image and the occupancy of each object may be a corresponding color. The occupancy data may include further information. For example, the occupancy data may be bounding box data for the objects represented by occupancies in the occupancy image. The diffusion model 204 can output the latent variable data 212 representing a behavior (e.g., a state or intent) of one or more objects at the second time. Further discussion of an example diffusion architecture is discussed in relation to FIG. 4, and elsewhere.

In various examples, the diffusion model 204 can determine the latent variable data 212 based at least in part on conditioning the input data (e.g., adding or removing noise from the input data) using the data 206, 208 and 210. In some examples, the diffusion model 204 can condition the input data based at least in part on one or more of: token information from a transformer model, node information from a GNN, scene information or other historical data. Token information can represent one or more tokens associated with objects in an environment including, in some examples, a token for an autonomous vehicle, a token to represent scene conditions, etc. Node information can include a node of a graph network associated with an object. Nodes or tokens of different objects can be used to condition the diffusion model 204 so that the latent variable data 212 represents different object states (e.g., a position, a trajectory, an orientation, and the like).

In some examples, the diffusion model 204 can employ cross-attention techniques to determine a relationship between a vehicle and an object, a first object and a second object, and so on. The diffusion model 204 can, for example, output the latent variable data 212 based at least in part on applying one or more cross attention algorithms to the conditional input.

The diffusion model 204 can operate directly using the data 206, 208 and 210 as the conditional input or may receive the conditional input from a machine learned model that may generate the conditional input based on data 206, 208 and 210.

In some examples, the conditional input can represent one or more of: an attribute (e.g., previous, current, or predicted position, velocity, acceleration, yaw, etc.) of the one or more objects, history of the object(s) (e.g., location history, velocity history, etc.), an attribute of the vehicle (e.g., velocity, position, etc.), and/or features of the environment (e.g., roadway boundary, roadway centerline, crosswalk permission, traffic light permission, and the like). For example, the conditional input can include the current occupancy data. As such, the conditional input can include historical, current or predicted state data associated with an object (e.g., the road 106 in FIG. 1) and/or a vehicle (e.g., vehicle 102) in an environment, such as in example environment 100. As mentioned, the state data can include, in various examples, one or more of position data, orientation data, heading data, velocity data, speed data, acceleration data, yaw rate data, or turning rate data associated with the object and/or the vehicle. In some examples, the conditional input can represent one or more control policies for use during a simulation (e.g., to associate with the scene data).

In various examples, a machine learned model can output the conditional input for sending to the diffusion model 204. The machine learned model can, for example, include one or more self-attention layers for determining “attention” or a relation between a first object and a second object (also referred to herein as cross attention data). In some examples, the machine learned model can be a transformer model or a GNN configured to generate cross attention data between two or more objects in an environment, but other machine learned model types are also contemplated.

In some examples, the conditional input can include a scalar value to represent the text data (or other condition data) that is not necessarily output by a machine learned model. However, the machine learned model is not shown in FIG. 2 because the machine learned model may not be used in all examples.

In some examples, the scene information associated with the conditional input can include the map data.

As mentioned above, a decoder of the variable autoencoder 202 may output predicted view data 214 based on the occupancy and/or map data 206 and latent variable data 212 received from the diffusion model 204. In the illustrated example, the predicted view data 214 includes the scene shown in the current view data 208 at a time subsequent to a time associated with the current view data 208.

As discussed above, the operations discussed above for FIG. 2 may be iterated by using the predicted view data 214 output by the variable autoencoder 202 as new current view data 208 (or generating new current view data 208 based on the predicted view data 214 output by the variable autoencoder 202). Each iteration may output new predicted view data 214 associated with a later time than the predicted view data 214 of the prior iteration.

Additionally or alternatively, the remote operation system may render the predicted view based on occupancy data, map data, and/or perception data. For example, rather than or in addition to generating a predicted view directly, the diffusion model 204 and variable autoencoder 202 may output predicted state data of the environment (e.g., predicted occupancy data). Then, using various rendering techniques, a simulated view may be rendered (e.g., using 3D models) for the predicted state data for presentation to the remote operator. While examples herein utilize machine learning techniques to determine a predicted state of an environment (e.g., directly as the predicted view image, a predicted environment state from which a view is rendered, or etc.), other examples may utilize programmatic techniques to determine movement of objects in the environment to generate a predicted state of the environment. For example, a system may determine a predicted state of the environment by determining a translation of a known object via its bounding box using deterministic code and then render the resulting predicted environment state using 3D models of the known objects and rendering/raytracing techniques (for example).

Additionally or alternatively, in some examples, the predicted view may be generated for a fixed time offset subsequent to the current sensor data, a variable time offset subsequent to the current sensor data (e.g., based on a latency of the current sensor data), or another offset (e.g. a number of internal states, processor cycles or so on). For example, the remote operation system 112 may vary the time offset for the predicted view by selecting from among diffusion models trained for different time offsets or by vary the timing of prediction data being input to the diffusion model 204 with the current view data.

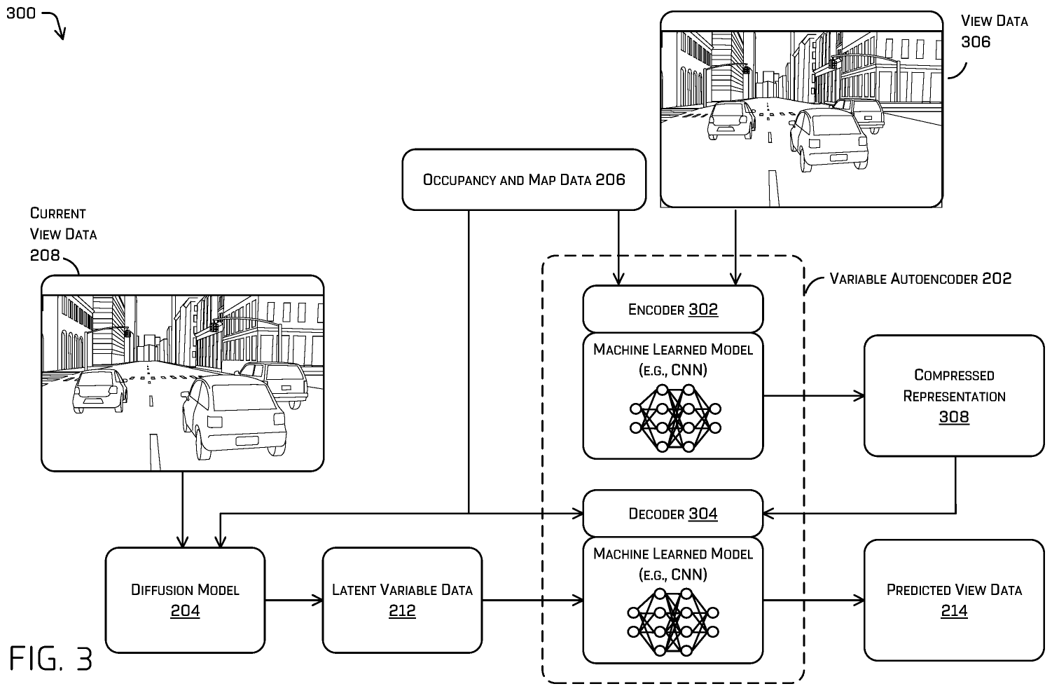

FIG. 3 illustrates an example block diagram 300 of an example variable autoencoder implemented by a computing device to generate example output data, as described herein. The techniques described in the example block diagram 300 may be performed by a computing device such as the remote operation system 112.

As depicted in FIG. 3, the variable autoencoder 202 of FIG. 2 comprising an encoder 302 and a decoder 304 that can be trained independently to output predicted view data 214 which may include the scene shown in the current view data 208 at a time subsequent to a time associated with the current view data 208. For instance, the encoder 302 of the variable autoencoder 202 can receive, as input data, view data 306 associated with a scene in the environment and the occupancy and/or map data 206 representing the environment. The encoder 302 can output a compressed representation 308 of the input data which represents a latent embedding. In various examples, the decoder 304 can receive the output data from the encoder and/or the latent variable data 212 from the diffusion model 204 (e.g., latent variable data can represent an action, intent, or attribute of an object for use in a simulation). In some examples, the decoder 304 may receive a compressed version of the view data 306 and/or a compressed version of the occupancy and/or map data 206 as input in examples that do not include the encoder 302 (e.g., independent of receiving the compressed input from an encoder). For example, the decoder 304 can output the predicted view data 214 by receiving compressed input data from a source other than the encoder 302.

In some examples, the encoder 302 and/or the decoder 304 can represent a machine learned model such as a CNN, a GNN, a GAN, an RNN, a transformer model, and the like. As discussed elsewhere herein, the encoder 302 can be trained based at least in part on the view data 306 and/or the occupancy and/or map data 206. In some examples, the occupancy and/or map data 206 can represent a top-down view of the environment (as indicated by the x and y axes). In some examples, the encoder 302 can receive the view data 306 as input. For example, the encoder 302 can receive the view data 306 as input and the decoder 304 can receive a compressed version of the view data 306 as input (not shown).

The occupancy data of the occupancy and/or map data 206 can indicate an area of the environment in which objects are likely to be located. The encoder 302 and/or the decoder 304 may also utilize bounding box data. For example, the occupancy data is associated with occupancy of an object whereas the bounding box data can include object information (a speed of the object, an acceleration of the object, a yaw of the object, etc.). The decoder 304 can be trained based at least in part on a loss between the predicted view data 214 output by the decoder 304 and the view data 306 input to the encoder 302. During training of the decoder, the predicted view data 214 may be associated with a same time as the view data 306. In some examples, the decoder 304 can be trained to improve a loss that takes into consideration the latent variable data 212 from the diffusion model 204.

The compressed representation 308 of the input data can represent a latent embedding (e.g., a representation of the input data in latent space). By determining the compressed representation 308, fewer computational resources are required for subsequent processing versus not compressing the input data.

An example of training the diffusion model 204 after training the encoder 302 and decoder 304 of the variable autoencoder 202 is discussed below with respect to FIG. 4.

FIG. 4 illustrates an example block diagram 400 of an example diffusion architecture implemented by a computing device to generate example output data, as described herein. As illustrated, the diffusion architecture may be a latent diffusion architecture including a variable autoencoder and a diffusion model (e.g., the variable autoencoder 202 and the diffusion model 204). The techniques described in the example block diagram 400 may be performed by a computing device such as the remote operation system 112.

For example, the computing device can implement the diffusion model 204 of FIG. 2 to generate the latent variable data 212 for use by a machine learned model such as the variable autoencoder 202. The diffusion model 204 comprises latent space 404 for performing various steps (also referred to as operations) including adding noise to input data during training (shown as part of the “diffusion process” in FIG. 4) and/or removing noise from input data during non-training operations. The diffusion model 204 can receive condition data 406 for use during different diffusion steps to condition the input data, as discussed herein. As discussed above, the condition data 406 may include or be generated based on the current view data 208, view data 306, occupancy and/or map data 206 and/or other condition data 210. For example, the condition data 406 can represent one or more of: a semantic label, text, an image, an object representation, an object behavior, a vehicle representation, historical information associated with an object and/or the vehicle, a scene label indicating a level of difficulty to associate with a simulation, an environment attribute, a control policy, or object interactions, to name a few.

In some examples, the condition data 406 can include a semantic label such as token information, node information, and the like. The condition data 406 can include, for example, text or an image describing an object, a scene, and/or a vehicle. In some examples, the condition data 406 can be a representation and/or a behavior associated with one or more objects in an environment. The condition data 406 may also or instead represent environmental attributes such as weather conditions, traffic laws, time of day, or data describing an object such as whether another vehicle is using a blinker or a pedestrian is looking towards the autonomous vehicle. In some examples, the condition data 406 represents one or more control policies that control a simulation (or object interactions thereof). In one non-limiting example, the condition data 406 can include specifying an object behavior, such as a level of aggression for a simulation that includes an autonomous vehicle.

FIG. 4 depicts the variable autoencoder 202 associated with pixel space 408 that includes an encoder 410 and a decoder 412. In some examples, the encoder 410 and the decoder 412 can represent an RNN or a multilayer perceptron (MLP). In some examples, the encoder 410 can receive an input (x) 414 (e.g., image data, occupancy data, map data, object state data, or other input data), and output embedded information Z in the latent space 404. In some examples, the embedded information Z can include a feature vector for each object to represent a trajectory, a pose, an attribute, a past trajectory, etc. In some examples, the input (x) 414 can represent image data from vehicle sensor data (e.g., a camera view). In some examples, the input (x) 414 can represent the occupancy and/or map data 206 that may include a top-down representation of an environment including a number of objects (e.g., can be determined by the condition data 406).

During training, the “diffusion process” can include applying an algorithm to apply noise to the embedded information Z to output a noisy latent embedding Z (T). When implementing the diffusion model 204 after training, the noisy latent embedding Z (T) (e.g., a representation of the input (x) 414) can be input into a de-noising neural network 416. The diffusion model 204 can initialize the noisy latent embedding Z (T) with random noise, and the de-noising neural network 416 (e.g., a CNN, a GNN, etc.) can apply one or more algorithms to determine an object intent based on applying different noise for different passes, or steps, to generate latent variable data that represents an object intent in the future. In some examples, multiple objects and object intents can be considered during denoising operations.

By way of example and not limitation, input to the de-noising neural network 416 can include a graph of nodes in which at least some nodes represent respective objects. In such examples, the input data can be generated with random features for each object, and the de-noising neural network 416 can include performing graph message passing operations for one or more diffusion steps. In this way, the de-noising neural network 416 can determine an object intent (e.g., a position, a trajectory, an orientation, etc.) for an object with consideration to the intent of other objects. By performing multiple diffusion steps, potential interactions between objects can change over time to best reflect how a diverse set of objects may behave in a real-world environment.

The condition data 406 can be used by the diffusion model 204 in a variety of ways including being concatenated with the noisy latent embedding Z (T) as input into the de-noising neural network 416. In some examples, the condition data 406 can be input during a de-noising step 418 applied to an output of the de-noising neural network 416. The de-noising step 418 represents steps to apply the condition data 406 over time to generate the embedded information Z which can be output to the decoder 412 in determining an output 420 representative of predicted view data and/or other predicted object state(s).

A training component (not shown) can train the diffusion model 204 based at least in part on a computed loss for the decoder 412 (e.g., the ability for the decoder to produce an output that is similar to ground truth view data or ground truth occupancy data that is associated with the same time as the view data 214). That is, the diffusion model can improve predictions over time based on being trained at least in part on a loss associated with the decoder 412 (e.g., the ability for the decoder to produce an output that is similar to ground truth view data or ground occupancy data associated with the same time as the view data 214). Additionally or alternatively, the training component (not shown) can train the diffusion model 204 based at least in part on a computed loss for the latent variable data 214 (e.g., the ability for the diffusion model to, based on current view data 208, occupancy and/or map data 206 associated with a first time, produce latent variable data 214 associated with a second time subsequent to the first time that is similar to a compressed representation output by the encoder 302 based on the ground truth view data, map data and/or ground truth occupancy data or ground truth bounding box data that is associated with the second time). In some examples, the decoder 412 can be trained based at least in part on a loss associated with the diffusion model 204.

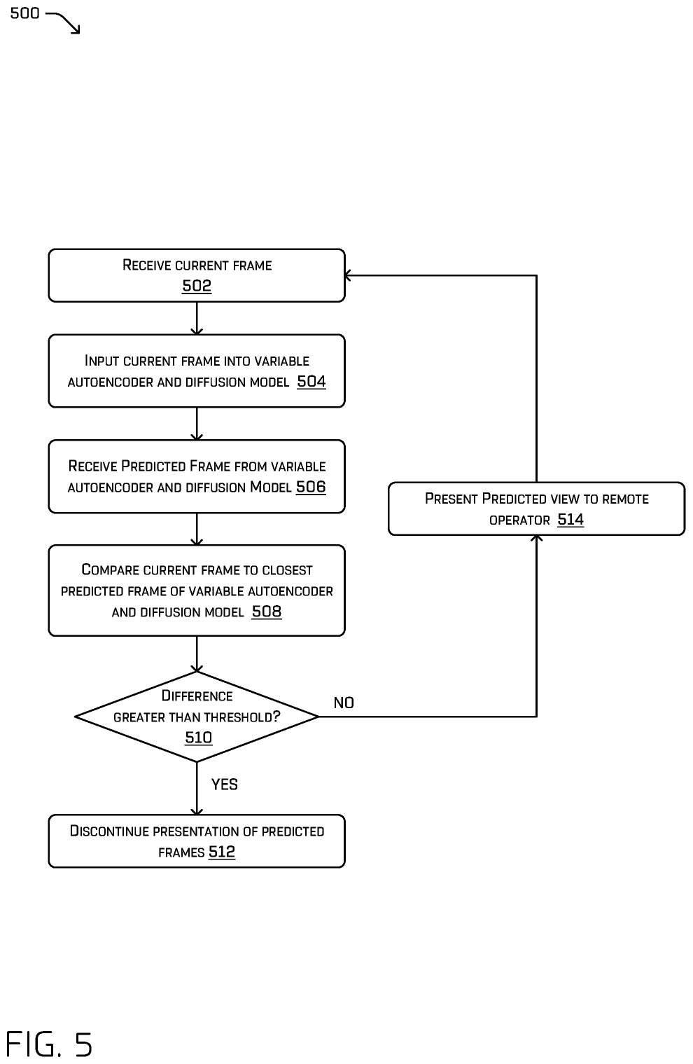

FIG. 5 illustrates an example process 500 for providing a remote operator with a predicted view while assisting a vehicle. The processes described herein are illustrated as collections of blocks in logical flow diagrams, which represent a sequence of operations, some or all of which may be implemented in hardware, software, or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIGS. 1-4, although the processes may be implemented in a wide variety of other environments, architectures and systems.

At operation 502, the process 500 may include receiving a current frame of sensor data and/or perception data associated with an autonomous vehicle. For example, the remote operation system 112 may receive image data captured by one or more cameras or other sensors of the vehicle. The image data may be included in data received from the vehicle that indicates an operational state of the vehicle 102. Such data may be received on a continual and/or periodic basis according to a predetermined schedule.

At operation 504, the process 500 may include inputting the current frame of image data into a variable autoencoder and diffusion model (e.g., such as shown in FIGS. 2-4). As discussed above, the process 500 may further include inputting other data into the variable autoencoder and diffusion model such as current or predicted data (e.g., occupancy data, bounding box data, etc.), map data, and so on.

At operation 506, the process 500 may include receiving a predicted frame of image data from the variable autoencoder and diffusion model. As mentioned above, the predicted frame of image data may be associated with a time subsequent to a time associated with the current image frame input to the variable autoencoder and diffusion model.

At operation 508, the process 500 may include comparing the current image frame to a previously predicted frame of variable autoencoder and diffusion model associated with a time closest to the time associated with the current image frame.

At operation 510, the process 500 may determine whether a difference between the current image frame and the previously predicted frame is greater than a threshold. If at operation 510, the process 500 determines that the difference is greater than the threshold, the process 500 may follow the “YES” route and proceed to operation 512. Alternatively, if the difference is not greater than the threshold, the process 500 may follow the “NO” route and proceed to operation 514.

At operation 512, the process may take various actions such as discontinuing the presentation of predicted view data, resetting the generation of predicted view data, adapting the current state of generating predicted view data based on the differences of the received current frame and the previously predicted frame, or so on.

At operation 514, the process may include presenting the predicted view via a user interface of remote computing device to the remote operator. The process may then return to 502.

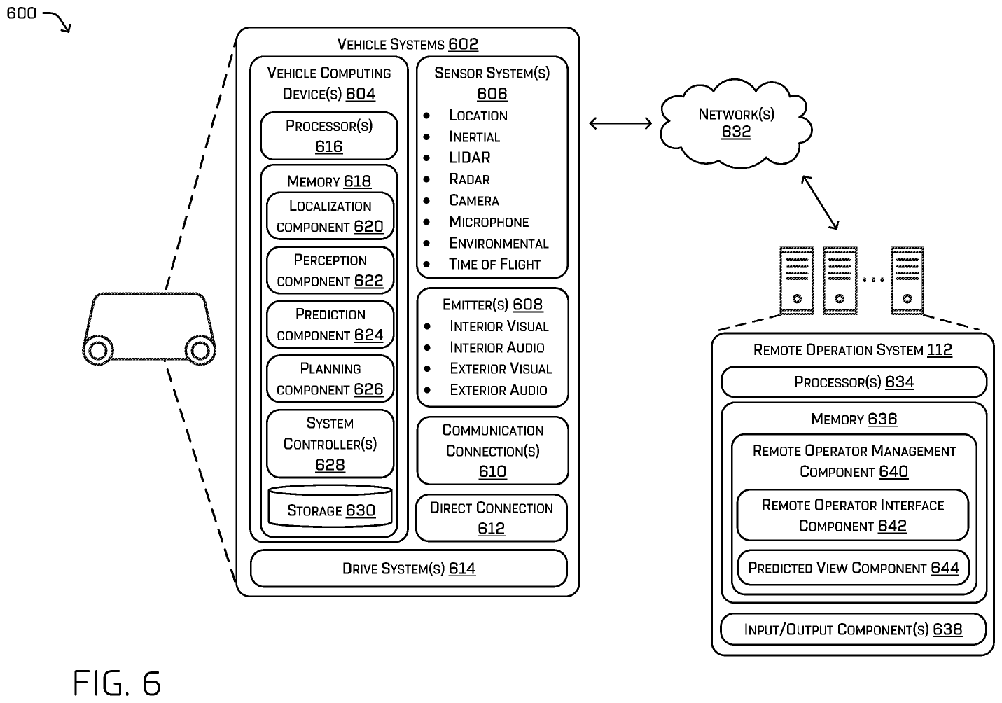

FIG. 6 is a block diagram of an architecture 600 including a vehicle system 602 for controlling operation of the systems that provide data associated with operation of the vehicle 102, and that control operation of the vehicle 102 in connection with the remote operation system 112. The vehicle system 602 can include one or more vehicle computing device(s) 604, one or more sensor system(s) 606, one or more emitter(s) 608, one or more communication connection(s) 610, at least one direct connection 612, and one or more drive system(s) 614.

The vehicle system 602 can be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. In such an example, since the vehicle system 602 can be configured to control all functions from start to stop, including all parking functions, it can be unoccupied. This is merely an example, and the systems and methods described herein can be incorporated into any ground-borne, airborne, or waterborne vehicle, including those ranging from vehicles that need to be manually controlled by a driver at all times, to those that are partially or fully autonomously controlled. That is, in the illustrated example, the vehicle system 602 is an autonomous vehicle; however, the vehicle system 602 could be any other type of vehicle. While only a single vehicle system 602 is illustrated in FIG. 6, in a practical application, the example system can include a plurality of vehicles, which, in some examples, can comprise a fleet of vehicles.

The vehicle computing device(s) 604, can include processor(s) 616 and memory 618 communicatively coupled with the processor(s) 616. In the illustrated example, the memory 618 of the vehicle computing device(s) 604 may store a localization component 620, a perception component 622, a prediction component 624, a planning component 626, and one or more system controller(s) 628. Additionally, the memory 618 can include storage 630, which can store map(s), model(s), etc., or any of the component(s) discussed above as being stored in the memory 618. As described above, a map can be any number of data structures that are capable of providing information about an environment, such as, but not limited to topologies (such as junctions, lanes, merging zones, etc.), streets, mountain ranges, roads, terrain, and the environment in general. Maps can be associated with real environments or simulated environments.

In some examples, the localization component 620 can determine a pose (position and orientation) of the vehicle system 602 in relation to a local and/or global map based at least in part on sensor data received from the sensor system(s) 606 and/or map data associated with a map (e.g., of the map(s)). In some examples, the localization component 620 can include, or be associated with a calibration system that is capable of performing operations for calibrating (determining various intrinsic and extrinsic parameters associated with any one or more of the sensor system(s) 606), localizing, and mapping substantially simultaneously. Additional details associated with such a system are described in U.S. patent application Ser. No. 15/675,487, filed on Aug. 11, 2017, which is related to U.S. patent application Ser. No. 15/674,853, filed on Aug. 11, 2017, the entire contents of both of which are incorporated by reference herein.

In some examples, the perception component 622 can perform object detection, segmentation, and/or classification based at least in part on sensor data received from the sensor system(s) 606. In some examples, the perception component 622 can receive raw sensor data (e.g., from the sensor system(s) 606). In some examples, the perception component 622 can receive sensor data and can utilize one or more sensor data processing algorithms (e.g., machine-learned model(s)) to perform object detection, segmentation, and/or classification with respect to object(s) identified in the sensor data. In some examples, the perception component 622 can associate a bounding box (or otherwise an instance segmentation) with an identified object and can associate a confidence score associated with a classification of the identified object with the identified object. In some examples, objects, when rendered via a display, can be colored based on their detected class. The perception component 622 can perform similar processes for one or more other sensor modalities.

The prediction component 624 can receive sensor data from the sensor system(s) 606, map data associated with a map (e.g., of the map(s) which can be in storage 630), and/or perception data output from the perception component 622 (e.g., processed sensor data), and can output predictions associated with one or more objects within the environment of the vehicle system 602. In some examples, the planning component 626 can determine routes and/or trajectories to use to control the vehicle system 602 based at least in part on sensor data received from the sensor system(s) 606 and/or any determinations made by the perception component 622 and/or prediction component 624.

In some examples, the planning component 626 can amalgamate (e.g., combine) operation state data from the data it obtains and/or from the correlated data it determines. For example, the operation state data may include: a representation of sensor data; detected object/event data that includes: a location of a detected object, a track of the detected object (e.g., a position, velocity, acceleration, and/or heading of the object), a classification (e.g., a label) of the detected object (for example, including sub-classes and subsets of classifications as discussed above), an identifier of a detected event, a confidence level (e.g., a percentage, an indicator that a classification and/or an identifier of a detected event is associated with an indicator of high unpredictability or low confidence), a rate of change of confidence levels over time, and/or a priority associated with the object(s) and/or event; path planning data that includes: a route, a progress of the vehicle along the route, a mission type (e.g., stop for additional passengers, pick up and deliver one passenger), passenger input, a trajectory, a pose of the vehicle, a geographic location of the autonomous vehicle, and/or a trajectory determined by the vehicle; vehicle state information that includes: a number of passengers occupying the vehicle, passenger input (e.g., speech, passenger state), an indication of vehicle and/or sensor health, an indication of vehicle history (e.g., past routes, past requests for assistance, past maintenance), a charge level of a battery of the vehicle, a distance of the vehicle from a fleet base of operations or charging station, an indication of whether a communication session is open between the vehicle and a remote operator device(s) and/or another vehicle, vehicle control data, a vehicle type (e.g., make, model, size, etc.), road network data (e.g., data related to a global or local map of an area associated with operation of the vehicle such as, for example, a location of the vehicle within a local map and/or an indication of whether vehicle data is normative for the location (e.g., whether a vehicle speed is above or below a speed limit indicated by the road network data, whether the vehicle is stopped at a position that is identified as being a stop location, whether the vehicle is within a predefined distance of a fleet-wide event)), communication channel information (e.g., bandwidth and/or quality of connection, identification of device(s) to which the vehicle is connected, predicted communication channel degradation), and/or previous remote operator guidance to the vehicle (e.g., direct instruction, collaboration, and/or confirmation); environmental data (e.g., in some examples this may be included in the representation of the sensor data or it may be acquired via the network interface) that includes: traffic information, weather information, city/regional events (e.g., acquired from social media, publications), time of day, and/or road network data (e.g., a processor-executable map accessible to the vehicle that identifies geographical locations as being a normal driving area, a drivable area, speed limits associated with geographical regions, event locations (e.g., accident location, location from which multiple requests have been sent), and/or an undriveable area and/or containing operating policies for a vehicle to operate therein).

In some examples, the planning component 626 may use at least a portion of the sensor data and/or the operation state data to determine a next action of the vehicle system 602 such as, for example, a trajectory and/or whether to send a request for assistance.

Additional details of localization systems, perception systems, prediction systems, and/or planning systems that are usable can be found in U.S. Pat. No. 9,612,123, issued on Apr. 4, 2017, and U.S. Pat. No. 10,353,390, issued on Jul. 16, 2019, the entire contents of both of which are incorporated by reference herein. In some examples (e.g., where the vehicle system 602 is not an autonomous vehicle), one or more of the aforementioned systems can be omitted from the vehicle system 602. While the systems described above are illustrated as “onboard” the vehicle system 602, in other implementations, the systems can be remotely located and/or accessible to the vehicle system 602. Furthermore, while the systems are described above as “systems,” such systems can comprise one or more components for performing operations attributed to each of the systems.

In some examples, the localization component 620, the perception component 622, the prediction component 624, and/or the planning component 626 can process sensor data, as described above, and can send their respective outputs over network(s) 632, to computing device(s) of the remote operation system 112. In some examples, the localization component 620, the perception component 622, the prediction component 624, and/or the planning component 626 can send their respective outputs to the computing device(s) of the remote operation system 112 at a particular frequency, after a lapse of a predetermined period of time, in near real-time, etc.

In some examples, the vehicle computing device(s) 604 can include one or more system controller(s) 628, which can be configured to control steering, propulsion, braking, safety, emitters, communication, and other systems of the vehicle system 602. These system controller(s) 628 can communicate with and/or control corresponding systems of the drive system(s) 614 and/or other systems of the vehicle system 602.

In some examples, the sensor system(s) 606 can include lidar sensors, radar sensors, ultrasonic transducers, sonar sensors, location sensors (e.g., GPS, compass, etc.), inertial sensors (e.g., inertial measurement units, accelerometers, magnetometers, gyroscopes, etc.), cameras (e.g., RGB, IR, intensity, depth, etc.), wheel encoders, audio sensors, environment sensors (e.g., temperature sensors, humidity sensors, light sensors, pressure sensors, etc.), ToF sensors, etc. The sensor system(s) 606 can include multiple instances of each of these or other types of sensors. The sensor system(s) 606 can provide input to the vehicle computing device(s) 604. In some examples, the sensor system(s) 606 can preprocess at least some of the sensor data prior to sending the sensor data to the vehicle computing device(s) 604. In some examples, the sensor system(s) 606 can send sensor data, via network(s) 632, to the remote operation system 112 at a particular frequency, after a lapse of a predetermined period of time, in near real-time, etc.

The vehicle system 602 can also include one or more emitter(s) 608 for emitting light and/or sound, as described above. The emitter(s) 608 in this example include interior audio and visual emitters to communicate with passengers of the vehicle system 602. By way of example and not limitation, interior emitters can include speakers, lights, signs, display screens, touch screens, haptic emitters (e.g., vibration and/or force feedback), mechanical actuators (e.g., seatbelt tensioners, seat positioners, headrest positioners, etc.), and the like. The emitter(s) 608 in this example also include exterior emitters. By way of example and not limitation, the exterior emitters in this example include light emitters (e.g., indicator lights, signs, light arrays, etc.) to visually communicate with pedestrians, other drivers, other nearby vehicles, etc., one or more audio emitters (e.g., speakers, speaker arrays, horns, etc.) to audibly communicate with pedestrians, other drivers, other nearby vehicles, etc., etc. In some examples, the emitter(s) 608 can be positioned at various locations about the exterior and/or interior of the vehicle system 602.

The vehicle system 602 can also include communication connection(s) 610 that enable communication between the vehicle system 602 and other local or remote computing device(s). For instance, the communication connection(s) 610 can facilitate communication with other local computing device(s) on the vehicle system 602 and/or the drive system(s) 614. Also, the communication connection(s) 610 can allow the vehicle to communicate with other nearby computing device(s) (e.g., other nearby vehicles, traffic signals, etc.). The communications connection(s) 610 also enable the vehicle system 602 to communicate with a remote operation system 112 or other remote services.

The communications connection(s) 610 can include physical and/or logical interfaces for connecting the vehicle computing device(s) 604 to another computing device or a network, such as network(s) 632. For example, the communications connection(s) 610 can enable Wi-Fi-based communication such as via frequencies defined by the IEEE 802.11 standards, short range wireless frequencies such as BLUETOOTH®, or any suitable wired or wireless communications protocol that enables the respective computing device to interface with the other computing device(s).

The direct connection 612 can directly connect the drive system(s) 614 and other systems of the vehicle system 602.

In some examples, the vehicle system 602 can include drive system(s) 614. In some examples, the vehicle system 602 can have a single drive system 614. In some examples, if the vehicle system 602 has multiple drive system(s) 614, individual drive system(s) 614 can be positioned on opposite ends of the vehicle system 602 (e.g., the front and the rear, etc.). In some examples, the drive system(s) 614 can include sensor system(s) to detect conditions of the drive system(s) 614 and/or the surroundings of the vehicle system 602. By way of example and not limitation, the sensor system(s) can include wheel encoder(s) (e.g., rotary encoders) to sense rotation of the wheels of the drive module, inertial sensors (e.g., inertial measurement units, accelerometers, gyroscopes, magnetometers, etc.) to measure position and acceleration of the drive module, cameras or other image sensors, ultrasonic sensors to acoustically detect objects in the surroundings of the drive module, lidar sensors, radar sensors, etc. Some sensors, such as the wheel encoder(s), can be unique to the drive system(s) 614. In some cases, the sensor system(s) on the drive system(s) 614 can overlap or supplement corresponding systems of the vehicle system 602 (e.g., sensor system(s) 606).

The drive system(s) 614 can include many of the vehicle systems, including a high voltage battery, a motor to propel the vehicle system 602, an inverter to convert direct current from the battery into alternating current for use by other vehicle systems, a steering system including a steering motor and steering rack (which can be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive system(s) 614 can include a drive module controller which can receive and preprocess data from the sensor system(s) and to control operation of the various vehicle systems. In some examples, the drive module controller can include processor(s) and memory communicatively coupled with the processor(s). The memory can store one or more modules to perform various functionalities of the drive system(s) 614. Furthermore, the drive system(s) 614 also include communication connection(s) that enable communication by the respective drive module with other local or remote computing device(s).

In FIG. 6, the vehicle computing device(s) 604, sensor system(s) 606, emitter(s) 608, and the communication connection(s) 610 are shown onboard the vehicle system 602. However, in some examples, the vehicle computing device(s) 604, sensor system(s) 606, emitter(s) 608, and the communication connection(s) 610 can be implemented outside of an actual vehicle (i.e., not onboard the vehicle system 602).

As shown in FIG. 6, the vehicle system 602 are configured to establish a communication link between the vehicle system 602 and one or more other devices. For example, the network(s) 632 may be configured to allow data to be exchanged between the vehicle system 602, other devices coupled to a network, such as other computer systems, other vehicles systems 602 in the fleet of vehicles, and/or with the remote operation system 112. For example, the network(s) 632 may enable wireless communication between numerous vehicles and/or the remote operation system 112. In various implementations, the network(s) 632 may support communication via wireless general data networks, such as a Wi-Fi network. For example, the network(s) 632 may support communication via telecommunications networks, such as, for example, cellular communication networks, satellite networks, and the like.

The remote operation system 112 can include processor(s) 634, memory 636, and input/output component(s) 638. In the illustrated example, the memory 636 of the remote operation system 112 stores a remote operator management component 640 that includes a remote operator interface component 642 and a predicted view component 644. The remote operator management component 640, the remote operator interface component 642 and the predicted view component 644 can include functionality to receive requests for rescue and dispatch assistance (e.g., vehicle 112 or a physical tow vehicle), provide predicted views to a remote operator providing remote assistance and so on as discussed herein with regard to FIGS. 1-5.

The processor(s) 616 of the vehicle system 602 and the processor(s) 634 of the remote operation system 112 can be any suitable processor capable of executing instructions to process data and perform operations as described herein. By way of example and not limitation, the processor(s) 616 and 634 can comprise one or more central processing units (CPUs), graphics processing units (GPUs), tensor processing units (TPUs) or any other device or portion of a device that processes electronic data to transform that electronic data into other electronic data that can be stored in registers and/or memory. In some examples, integrated circuits (e.g., ASICs, etc.), gate arrays (e.g., FPGAs, etc.), and other hardware devices can also be considered processors in so far as they are configured to implement encoded instructions.

Memory 618 and 636 are examples of non-transitory computer-readable media. Memory 618 and 636 can store an operating system and one or more software applications, instructions, programs, and/or data to implement the methods described herein and the functions attributed to the various systems. In various implementations, the memory can be implemented using any suitable memory technology, such as static random receive memory (SRAM), synchronous dynamic RAM (SDRAM), nonvolatile/Flash-type memory, or any other type of memory capable of storing information. The architectures, systems, and individual elements described herein can include many other logical, programmatic, and physical components, of which those shown in the accompanying figures are merely examples that are related to the discussion herein.

In various implementations, the parameter values and other data illustrated herein may be included in one or more data stores and may be combined with other information not described or may be partitioned differently into more, fewer, or different data structures. In some implementations, data stores may be physically located in one memory or may be distributed among two or more memories.

Those skilled in the art will appreciate that the architecture 600 is merely illustrative and is not intended to limit the scope of the present disclosure. In particular, the computing system and devices may include any combination of hardware or software that may perform the indicated functions, including computers, network devices, internet appliances, tablet computers, PDAs, wireless phones, pagers, etc. The architecture 600 may also be connected to other devices that are not illustrated, or instead may operate as a stand-alone system. In addition, the functionality provided by the illustrated components may in some implementations be combined in fewer components or distributed in additional components. Similarly, in some implementations, the functionality of some of the illustrated components may not be provided and/or other additional functionality may be available.

Those skilled in the art will also appreciate that, while various items are illustrated as being stored in memory or storage while being used, these items or portions of them may be transferred between memory and other storage devices for purposes of memory management and data integrity. Alternatively, in other implementations, some or all of the software components may execute in memory on another device and communicate with the illustrated architecture 600. Some or all of the system components or data structures may also be stored (e.g., as instructions or structured data) on a non-transitory, computer-accessible medium or a portable article to be read by an appropriate drive, various examples of which are described above. In some implementations, instructions stored on a computer-accessible medium separate from the architecture 600 may be transmitted to the architecture 600 via transmission media or signals such as electrical, electromagnetic, or digital signals, conveyed via a communication medium such as a wireless link. Various implementations may further include receiving, sending, or storing instructions and/or data implemented in accordance with the foregoing description on a computer-accessible medium. Accordingly, the techniques described herein may be practiced with other control system configurations. Additional information about the operations of the modules of the vehicle system 602 is discussed below.

### EXAMPLE CLAUSES

The following paragraphs describe various examples. Any of the examples in this section may be used with any other of the examples in this section and/or any of the other examples or embodiments described herein.

A. A remote operations system comprising: at least one processor; and at least one non-transitory memory having stored thereon processor-executable instructions that, when executed by the at least one processor, configure the remote operations system to: receive, from an autonomous vehicle, a request for remote operator assistance; receive, from the autonomous vehicle, data associated with the autonomous vehicle, the data associated with the autonomous vehicle including one or more of an image associated with a first time or occupancy data associated with an environment of the autonomous vehicle associated with the first time; generate, by a machine-learned model and based on the data associated with the autonomous vehicle, a predicted image associated with a second time subsequent to the first time, the predicted image depicting a predicted view at the second time; display the predicted view via the remote operations system; receive an input from a remote operator; and transmit, based at least in part on the input, guidance to the autonomous vehicle, the guidance configured to be used by the autonomous vehicle as part of controlling the autonomous vehicle.

B. The remote operations system of clause A, the remote operations system being further configured to: determine the second time based at least in part on determining latency associated with at least one of receiving the data associated with the autonomous vehicle or displaying the data associated with the autonomous vehicle via the remote operations system, wherein generating the predicted image is further based at least in part on the second time.

C. The remote operations system of clause B, the remote operations system being further configured to: receive additional sensor data including a second image captured at a third time subsequent the first time and within a threshold difference of time from the second time; determine a similarity of the second image to the predicted image; and in response to the similarity being below a threshold, discontinuing display of predicted images via the remote operations system.

D. The remote operations system of clause A, wherein generating the predicted image based on the image comprises: generating, by a diffusion model and based at least in part on the image, latent variable data, wherein the latent variable data is associated with the second time; and generating, by a decoder and based at least in part on the latent variable data, the predicted image.

E. The remote operations system of clause D, wherein generating the predicted image is based on map data and an object trajectory of the occupancy data associated with an object in the environment associated with the autonomous vehicle.

F. The remote operations system of clause D, wherein the diffusion model is configured to perform a denoising algorithm based at least in part on the image to generate the latent variable data.

G. A method, comprising: initializing a connection from a remote operations system and to an autonomous vehicle, for remote operator assistance; receiving, from the autonomous vehicle, sensor data associated with the autonomous vehicle, the sensor data associated with a first time; generating, based on the sensor data, a predicted image associated with a second time subsequent to the first time, the predicted image depicting a predicted view at the second time; and displaying the predicted image via the remote operations system.

H. The method of clause G, further comprising: determining the second time based at least in part on determining latency associated with at least one of receiving the sensor data from the autonomous vehicle or displaying the sensor data via the remote operations system, wherein generating the predicted image is further based at least in part on the second time.

I. The method of clause H, further comprising: receiving additional sensor data including a second image captured at a third time subsequent the first time and within a threshold difference of time from the second time; determining a similarity of the second image to the predicted image; and in response to the similarity being below a threshold, discontinuing display of predicted images via the remote operations system.

J. The method of clause G, wherein generating the predicted image based on the sensor data comprises: generating, by a diffusion model and based at least in part on an image included in the sensor data, latent variable data, wherein the latent variable data is associated with the second time; and generating, by a decoder and based at least in part on the latent variable data, the predicted image.

K. The method of clause G, wherein generating the predicted image is based on map data and occupancy data associated with an object in an environment associated with the autonomous vehicle.

L. The method of clause J, wherein the diffusion model is configured to perform a denoising algorithm based at least in part on the image to generate the latent variable data.

M. The method of clause G, the method further comprising: receiving an input from a remote operator; and transmit, based at least in part on the input, guidance to the autonomous vehicle, the guidance configured to be used by the autonomous vehicle as part of controlling the autonomous vehicle in an environment.

N. One or more non-transitory computer-readable media storing instructions that, when executed by one or more processors, cause the one or more processors to perform actions comprising: initializing a connection from a remote operations system and to an autonomous vehicle, for remote operator assistance; receiving, from the autonomous vehicle, sensor data associated with the autonomous vehicle, the sensor data associated with a first time; generating, based on the sensor data, a predicted image associated with a second time subsequent to the first time, the predicted image depicting a predicted view at the second time; and displaying the predicted image via the remote operations system.

O. The one or more non-transitory computer-readable media of clause N, wherein: determining the second time based at least in part on determining latency associated with at least one of receiving the sensor data from the autonomous vehicle or displaying the sensor data via the remote operations system, wherein generating the predicted image is further based at least in part on the second time.

P. The one or more non-transitory computer-readable media of clause O, the actions further comprising: receiving additional sensor data including a second image captured at a third time subsequent the first time and within a threshold difference of time from the second time; determining a similarity of the second image to the predicted image; and in response to the similarity being below a threshold, discontinuing display of predicted images via the remote operations system.

Q. The one or more non-transitory computer-readable media of clause N, wherein generating the predicted image based on the sensor data comprises: generating, by a diffusion model and based at least in part on an image included in the sensor data, latent variable data, wherein the latent variable data is associated with the second time; and generating, by a decoder and based at least in part on the latent variable data, the predicted image.

R. The one or more non-transitory computer-readable media of clause N, wherein the predicted image is based on map data and occupancy data associated with an object in an environment associated with the autonomous vehicle.

S. The one or more non-transitory computer-readable media of clause Q, wherein the diffusion model is configured to perform a denoising algorithm based at least in part on the image to generate the latent variable data.

T. The one or more non-transitory computer-readable media of clause N, the actions further comprising: receiving an input from a remote operator; and transmit, based at least in part on the input, guidance to the autonomous vehicle, the guidance configured to be used by the autonomous vehicle as part of controlling the autonomous vehicle in an environment.

While the example clauses described above are described with respect to one particular implementation, it should be understood that, in the context of this document, the content of the example clauses may also be implemented via a method, device, system, computer-readable medium, and/or another implementation. Additionally, any of examples A-T may be implemented alone or in combination with any other one or more of the examples A-T.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code components and/or computer-executable instructions executed by one or more computers or processors, hardware, or some combination thereof. Some or all of the methods may alternatively be embodied in specialized computer hardware.

At least some of the processes discussed herein are illustrated as logical flow graphs, each operation of which represents a sequence of operations that can be implemented in hardware, software, or a combination thereof. In the context of software, the operations represent computer-executable instructions stored on one or more non-transitory computer-readable storage media that, when executed by one or more processors, cause a computer or autonomous vehicle to perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. Such processes, or any portion thereof, may be performed iteratively in that any or all of the steps may be repeated. Of course, the disclosure is not meant to be so limiting and, as such, any process performed iteratively may comprise, in some examples, performance of the steps a single time.

Conditional language such as, among others, “may,” “could,” “may” or “might,” unless specifically stated otherwise, are understood within the context to indicate that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a,” “an” or other similar articles means singular and/or plural. When referring to a collection of items as a “set,” it should be understood that the definition may include, but is not limited to, the common understanding of the term in mathematics to include any number of items including a null set (0), 1, 2, 3, . . . up to and including an infinite set.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art. Note that the term substantially may indicate a range. For example, substantially simultaneously may indicate that two activities occur within a time range of each other, substantially a same dimension may indicate that two elements have dimensions within a range of each other, and/or the like.

Many variations and modifications may be made to the above-described examples, the elements of which are to be understood as being among other acceptable examples. All such modifications and variations are intended to be included herein within the scope of this disclosure and protected by the following claims.

What is claimed is:

1. A remote operations system comprising:
at least one processor; and
at least one non-transitory memory having stored thereon processor-executable instructions that, when executed by the at least one processor, configure the remote operations system to:
receive, from an autonomous vehicle, a request for remote operator assistance;
receive, from the autonomous vehicle, data associated with the autonomous vehicle, the data associated with the autonomous vehicle including one or more of an image associated with a first time or occupancy data associated with an environment of the autonomous vehicle associated with the first time;
generate, by a machine-learned model and based on the data associated with the autonomous vehicle, a predicted image associated with a second time subsequent to the first time, the predicted image depicting a predicted view at the second time;
display the predicted view via the remote operations system;
receive an input from a remote operator; and
transmit, based at least in part on the input, guidance to the autonomous vehicle, the guidance configured to be used by the autonomous vehicle as part of controlling the autonomous vehicle.

2. The remote operations system of claim 1, the remote operations system being further configured to:
determine the second time based at least in part on determining latency associated with at least one of receiving the data associated with the autonomous vehicle or displaying the data associated with the autonomous vehicle via the remote operations system,
wherein generating the predicted image is further based at least in part on the second time.

3. The remote operations system of claim 2, the remote operations system being further configured to:
receive additional sensor data including a second image captured at a third time subsequent the first time and within a threshold difference of time from the second time;
determine a similarity of the second image to the predicted image; and
in response to the similarity being below a threshold, discontinuing display of predicted images via the remote operations system.

4. The remote operations system of claim 1, wherein generating the predicted image based on the image comprises:
generating, by a diffusion model and based at least in part on the image, latent variable data, wherein the latent variable data is associated with the second time; and
generating, by a decoder and based at least in part on the latent variable data, the predicted image.

5. The remote operations system of claim 4, wherein generating the predicted image is based on map data and an object trajectory of the occupancy data associated with an object in the environment associated with the autonomous vehicle.

6. The remote operations system of claim 4, wherein the diffusion model is configured to perform a denoising algorithm based at least in part on the image to generate the latent variable data.

7. A method, comprising:
initializing a connection from a remote operations system and to an autonomous vehicle, for remote operator assistance;
receiving, from the autonomous vehicle, sensor data associated with the autonomous vehicle, the sensor data associated with a first time;
generating, based on the sensor data, a predicted image associated with a second time subsequent to the first time, the predicted image depicting a predicted view at the second time; and
displaying the predicted image via the remote operations system.

8. The method of claim 7, further comprising:
determining the second time based at least in part on determining latency associated with at least one of receiving the sensor data from the autonomous vehicle or displaying the sensor data via the remote operations system,
wherein generating the predicted image is further based at least in part on the second time.

9. The method of claim 8, further comprising:
receiving additional sensor data including a second image captured at a third time subsequent the first time and within a threshold difference of time from the second time;
determining a similarity of the second image to the predicted image; and
in response to the similarity being below a threshold, discontinuing display of predicted images via the remote operations system.

10. The method of claim 7, wherein generating the predicted image is based on map data and occupancy data associated with an object in an environment associated with the autonomous vehicle.

11. The method of claim 7, wherein generating the predicted image based on the sensor data comprises:
generating, by a diffusion model and based at least in part on an image included in the sensor data, latent variable data, wherein the latent variable data is associated with the second time; and
generating, by a decoder and based at least in part on the latent variable data, the predicted image.

12. The method of claim 11, wherein the diffusion model is configured to perform a denoising algorithm based at least in part on the image to generate the latent variable data.

13. The method of claim 7, the method further comprising:
receiving an input from a remote operator; and
transmit, based at least in part on the input, guidance to the autonomous vehicle, the guidance configured to be used by the autonomous vehicle as part of controlling the autonomous vehicle in an environment.

14. One or more non-transitory computer-readable media storing instructions that, when executed by one or more processors, cause the one or more processors to perform actions comprising:
initializing a connection from a remote operations system and to an autonomous vehicle, for remote operator assistance;
receiving, from the autonomous vehicle, sensor data associated with the autonomous vehicle, the sensor data associated with a first time;
generating, based on the sensor data, a predicted image associated with a second time subsequent to the first time, the predicted image depicting a predicted view at the second time; and
displaying the predicted image via the remote operations system.

15. The one or more non-transitory computer-readable media of claim 14, wherein:
determining the second time based at least in part on determining latency associated with at least one of receiving the sensor data from the autonomous vehicle or displaying the sensor data via the remote operations system,
wherein generating the predicted image is further based at least in part on the second time.

16. The one or more non-transitory computer-readable media of claim 15, the actions further comprising:
receiving additional sensor data including a second image captured at a third time subsequent the first time and within a threshold difference of time from the second time;
determining a similarity of the second image to the predicted image; and
in response to the similarity being below a threshold, discontinuing display of predicted images via the remote operations system.

17. The one or more non-transitory computer-readable media of claim 14, wherein generating the predicted image based on the sensor data comprises:
generating, by a diffusion model and based at least in part on an image included in the sensor data, latent variable data, wherein the latent variable data is associated with the second time; and
generating, by a decoder and based at least in part on the latent variable data, the predicted image.

18. The one or more non-transitory computer-readable media of claim 17, wherein the diffusion model is configured to perform a denoising algorithm based at least in part on the image to generate the latent variable data.

19. The one or more non-transitory computer-readable media of claim 14, wherein the predicted image is based on map data and occupancy data associated with an object in an environment associated with the autonomous vehicle.

20. The one or more non-transitory computer-readable media of claim 14, the actions further comprising:
receiving an input from a remote operator; and
transmit, based at least in part on the input, guidance to the autonomous vehicle, the guidance configured to be used by the autonomous vehicle as part of controlling the autonomous vehicle in an environment.
